(19) United States
(12) Patent Application Publication
(10) Pub. No.: US 2023/0192458 A1
(43) Pub. Date: Jun. 22, 2023

(54) NUT GAP SENSING SYSTEM

(71) Applicant: Nabholz Construction Corporation, Conway, AR (US)

(72) Inventors: Mark Raymond Potter, Stratford, CT (US); Stephen Harold Schumacher, Sandy Hook, CT (US)

(21) Appl. No.: 17/552,705

(22) Filed: Dec. 16, 2021

(51) Int. Cl. B66F 7/02

(52) U.S. Cl. CPC B66F 7/025; B66F 2700/04

(57) ABSTRACT

A drop table can employ a number of lifting columns respectively arranged with a nut and traveler each positioned on a rotating core with the nut separated from the traveler by a nut gap. The nut gap may be measured with a first sensor positioned within the nut and the first sensor detecting a nut gap distance with a first sensing feature. The first sensor can be changed to a second sensor that detects the nut gap distance with a second sensing feature that is different than the first sensing feature.

### RELATED APPLICATION

The present application makes a claim of domestic priority to U.S. Utility patent application Ser. No. 16/459,786 filed Jul. 2, 2019, the contents of which are hereby incorporated by reference.

### SUMMARY

A nut gap of a lifting column, in some embodiments, has a nut and traveler each positioned on a rotating core with the nut separated from the traveler by a nut gap. The nut gap is measured with a first sensor positioned within the nut and the first sensor detecting a nut gap distance with a first sensing feature. The first sensor is subsequently changed to a second sensor that detects the nut gap distance with a second sensing feature that is different than the first sensing feature.

A lifting column, in other embodiments, has a nut and traveler each positioned on a rotating core with the nut separated from the traveler by a nut gap. A load is lifted by activating the rotating core prior to adding at least one attachment feature to the nut that allows for installation of a sensor to measure the nut gap while contacting the at least one attachment feature.

In accordance with assorted embodiments, a lifting column has a nut and traveler each positioned on a rotating core with the nut separated from the traveler by a nut gap. A first portion of the nut gap is measured with a first sensor positioned within the nut and arranged to detect a nut gap distance with a first sensing feature. A second portion of the nut gap is measured with a second sensor arranged to detect the nut gap distance with a second sensing feature. The first sensing feature is different than the second sensing feature.

### BRIEF DESCRIPTION OF THE DRAWINGS

FIG. 1 is a block representation of an example maintenance system in which various embodiments can be practiced.

FIG. 2 depicts a block representation of an example drop table system arranged in accordance with various embodiments.

FIGS. 3A & 3B represents portions of an example drop table capable of being used in the systems of FIGS. 1 & 2.

FIG. 4 displays portions of an example lifting column arranged in accordance with assorted embodiments.

FIGS. 5A & 5B respectively depict portions of an example lifting column configured and operated in accordance with some embodiments.

FIGS. 6A & 6B respectively depict portions of an example lifting column that can be utilized in accordance with various embodiments.

FIGS. 7A & 7B respectively depict portions of an example lifting column capable of being employed in a drop table in some embodiments.

FIG. 8 depicts portions of an example lifting column configured in accordance with embodiments of a drop table.

FIG. 9 depicts a flowchart of an example sensor routine that can be performed in a lifting column in accordance with assorted embodiments.

FIG. 10 is an example nut gap sensing routine that can be carried out with various embodiments of FIGS. 1-9.

### DETAILED DESCRIPTION

A drop table employing one or more lifting columns can utilize a nut gap to detect operating parameters. Embodiments of this disclosure generally relate to sensing configurations that provide dynamic nut gap monitoring capabilities along with more efficient maintenance.

Mechanization has allowed difficult tasks be conducted faster and safer. However, some mechanization equipment can involve increased volumes of maintenance and/or maintenance time that is needed to provide the equipment's full capabilities. Some maintenance can involve the lifting, or lowering, of relatively heavy equipment, while components are removed and serviced. Such lifting can be conducted with one or more lifting assemblies that utilize mechanical, hydraulic, and/or pneumatic means to articulate the position of attached equipment.

While the moving assemblies, such as lifting columns, may be capable of safely handling small-scale equipment can be relatively simple, the vertical articulation of heavy machinery, such as equipment weighing one ton or more, can involve complex and/or cumbersome. For example, a drop table capable of raising and lowering vehicle components weighing fifty tons can employ multiple separate lifting assemblies acting in unison. Hence, where heavy loads and/or long vertical distances are to traversed, lifting assemblies are relied upon for accurate, consistent, and reliable operation in order to protect the load being moved as well as the safety of personnel and equipment nearby.

With these issues in mind, a drop table assembly, in accordance with some embodiments, senses a nut gap with more than one sensor to detect a nut gap distance between components positioned on a rotating core. The ability to utilize redundant and/or different sensors in a diverse variety of positions relative to a nut gap allows for intelligent monitoring of a nut gap distance, retrofitting of sensors, and sensor interchangeability. The combination of multiple sensors provides real-time nut gap distance measuring that can be efficiently changed and serviced to adapt to changing operating conditions and/or maintain optimal nut gap monitoring performance.

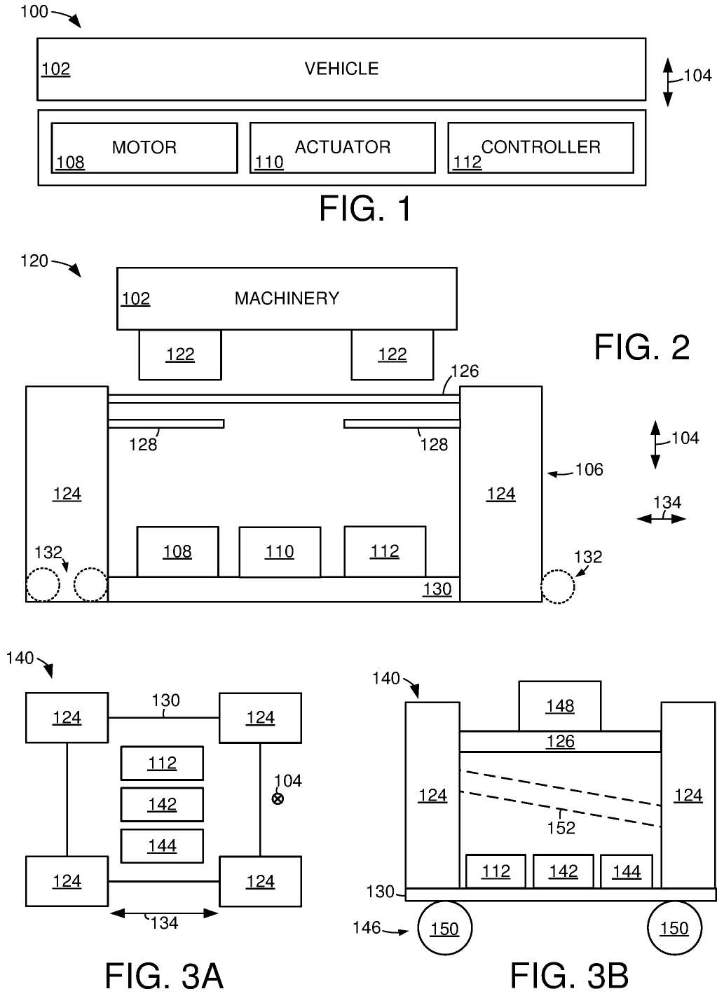

In FIG. 1, a block representation of an example maintenance system 100 depicts an environment in which various embodiments can be practiced. The system 100 can be configured to service any type, and size, of machinery, such as a vehicle 102. It is contemplated that more than one vehicle 102 can concurrently be accessed and serviced, but such arrangement is not required or limiting.

Although assorted maintenance can be facilitated without physically moving the machinery 102, such as engine tuning or joint greasing, other maintenance requires the separation of one or more components from the vehicle 102. Such separation can be conducted either by lifting the machinery 102 while a component remains stationary or by lowering the component while the machinery 102 remains stationary. Due to the significant weight and overall size of some machinery 102, such as a locomotive engine or railcar, the maintenance system 100 is directed to moving a component vertically, as represented by arrow 104, with a lifting mechanism 106 while the remainder of the machinery 102 remains stationary.

The lifting mechanism 106 can consist of at least a motor 108, or engine, that allows one or more actuators 110 to physically engage and move vehicle component. A local controller 112 can direct motor 108 and actuator 110 operation and may be complemented with one or more manual inputs, such as a switch, button, or graphical user interface (GUI), that allow customized movement of the machinery component. The local controller 112 can conduct a predetermined lifting protocol that dictates the assorted forces utilized by the motor 108 and actuator 110 to efficiently and safely conduct vertical component displacement.

In accordance with some embodiments, the lifting mechanism 106 can be characterized as a drop table onto which the machinery 102 moves to position a component in place to enable component removal, and subsequent installation. FIG. 2 depicts a block representation of an example lifting system 120 arranged to provide maintenance operations for machinery 102. A lifting mechanism 106 can consist of one or more motors 108, actuators 110, and controllers 112 that are utilized to engage and secure a machinery component 122, such as a wheel, suspension, engine, or body, throughout a range of vertical motion 104.

Depending on the position and size of the component 122, the lifting mechanism 106 can vertically manipulate the component 122 itself or the machinery 102 as a whole to allow efficient access, removal, and subsequent installation of the component 122 to be serviced. That is, the lifting mechanism 106 can be utilized to separate a component 122 from machinery 102 by keeping the component 122 stationary while vertically moving the rest of the machinery 102 or by keeping the machinery 102 stationary while vertically moving the component 122 by itself.

It is contemplated that the lifting mechanism 106 can consist of one or more lifting columns 124 that operate collectively to vertically displace a component 122. In some embodiments, multiple separate lifting columns 124 each raise a platform 126, as shown in FIG. 2. That is, lifting columns 124 that are physically separated can be concurrently activated to apply force on a platform 126 that physically supports the component 122. Such unified lifting column 124 and platform 126 can provide consistent operation over time as deviations in operating characteristics, such as lifting speed and precision, are mitigated by the platform 126 that physically brings the respective lifting columns 124 into similar operating characteristics. However, the use of a unifying platform 126 can make the lifting mechanism 106 rather large and physically restrictive to machinery 102 and/or components 122 of certain sizes and shapes.

Other embodiments configure the lifting mechanism 106 of multiple separate lifting columns 124 that each contact different portions of a component 122 via independent protrusions 128. The use of independent lifting columns 124 can provide increased physical compatibility with diverse machinery 102 and/or component 122 shapes and sized. In yet, independent lifting columns 124 can be more susceptible to component 124 instability during lifting operations as a result of deviations in operating characteristics for the respective columns 124. Such independent lifting column 124 configuration also suffers from increased complexity compared to using a unifying platform 126 due to the coordination of the respective column's 124 operation to provide secure component 122 movement.

It is contemplated that a lifting column 124 can be secured to a base 130, such as a floor, foundation, or frame. A base 130 can be constructed to be permanently stationary or move upon activation to relocate the collective lifting columns 124. The rigid connection of each lifting column 124 to a base 130 can provide increased strength to the lifting mechanism 106, but can limit the operational flexibility of the system 120. Conversely, the respective lifting columns 124 can have transport assemblies 132, such as a suspension, wheels, or tracks, that allow a column 124 to move relative to a base 130 via manual or automated manipulation.

In accordance with various embodiments, multiple lifting columns 124 can be mounted to a base 130 that can provide vertical 104 and horizontal 134 movement of relatively large loads, such as 50 tons or more. Such lifting column 124 configuration can be generally characterized as a drop table, which is depicted in the lifting system 140 of FIGS. 3A & 3B. The top view of FIG. 3A displays a platform 126 disposed between and physically attached to multiple lifting columns 124. As directed by a local controller 112, one or more lifting motors 142, or engines, can articulate aspects of the respective columns 124 to move the platform 126 in the vertical direction 104. The controller 112 may further direct one or more transverse motors 144, or engines, to activate a drive line 146 and move the platform 126 along the horizontal direction 134.

It is contemplated that one or more lifting columns 124 are physically separated from the platform 126, but such configuration would necessitate individual motors 142/144 for each column 124 along with complex spatial sensing and coordination to ensure a load 148 is securely lifted and moved. Instead, the platform 126 physically unifies the respective lifting columns 124 and provides a foundation onto which the load 148 can rest and provide a consistent center of gravity throughout lifting 104 and horizontal 134 movement activities.

FIG. 3B displays side view and an example physical layout of the lifting system 140 where a base 130 remains stationary while the platform 126 is vertically translated. The base 130 provides a secure foundation for the various motors 142/144 and associated transmission to the respective lifting columns 124. The base 130 further anchors the drive line 146 and number of constituent rollers 150, which can be wheels, castors, trucks, or other assembly utilizing a bearing. During normal operation, the assorted lifting columns 124 provide uniform platform 126 lifting and lowering.

However, the fact that the multiple lifting columns 124 can independently experience failures increases the operational risk of less than all of the columns 124 experiencing an error. When a lifting column 124 experiences a failure while other columns 124 continue to operate, the platform 126 can become unstable, as illustrated by segmented platform 152, and the very heavy load 148 can be at risk of damage and/or damaging the lifting system 140 as well as nearby equipment and users. Hence, the use of independent lifting motors 142, or independent lifting columns 124 separate from a platform 126, can be particularly dangerous. Furthermore, independent lifting columns 124 provide less physical space for motors 142 and limit the available motor size and power that can be safely handled by a column 124, which reduces the efficiency and safety of lifting heavy loads 148 safely, such as over 10 tons.

In contrast to independent lifting columns 124 having independent lifting motors 142, it is contemplated that a single motor can be employed to power the respective columns 124 collectively. While the base 130 could provide enough space and rigidity to handle a single motor/engine 142, the failure rates and operational longevity of a motor/engine 142 capable of lifting a load 128 weighing tens of tons can involve increased service times and frequency that can be prohibitive in terms of lifting system 140 operational efficiency. In addition, it is noted that large parasitic energy losses can be experienced through transmission that translates the power output of a single motor/engine 142 to four separate lifting columns 124.

Accordingly, various embodiments employ a lifting motor 142 to power two separate lifting columns 124 that are unified by a single platform that is vertically manipulated by the collective operation of the lifting columns 124 and dual drive motors 142. The combination of two lifting motors 142 to power four columns 124 provides an enhanced motor efficiency via relatively simple transmissions, lower service times/frequency, and relatively simple motor 142 coordination compared to independent columns 124 or a single motor powering four columns 124.

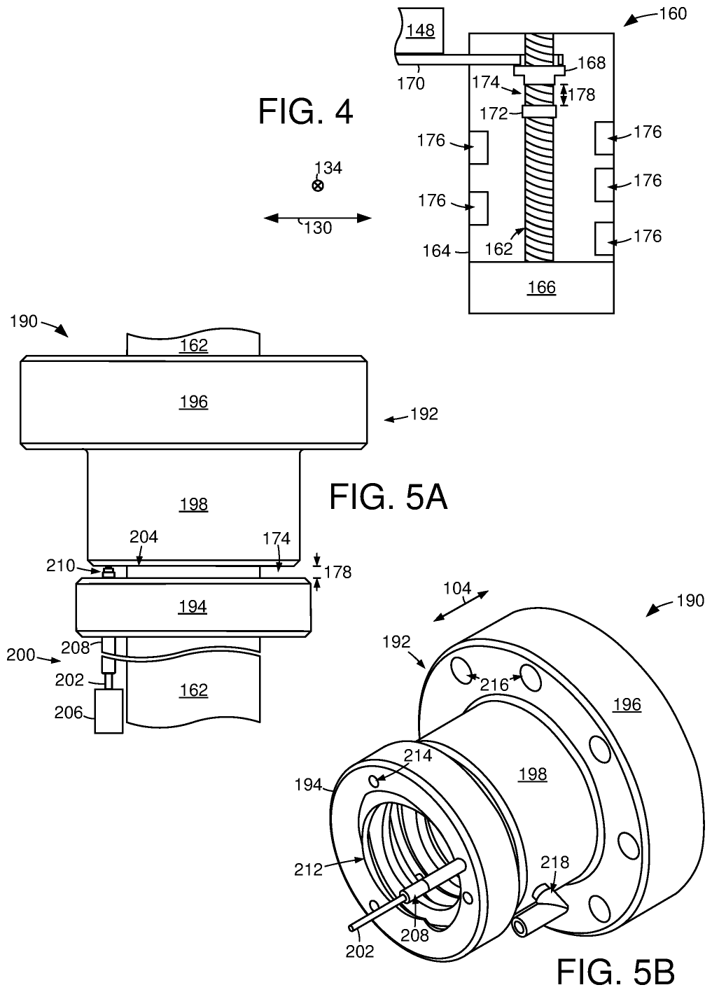

FIG. 4 depicts portions of an example lifting column 160 configured in accordance with some embodiments to provide efficient and safe lifting operations as part of a lifting system. It is noted that the lifting column 160 may operate alone, or in concert with one or more lifting columns 160 to vertically manipulate a load with, or without, a platform extending between columns 160. Through bidirectional activation of at least one column 160, a physically attached load 148 can have vertical movement 104 safely and reliably with minimal load motion and/or vibration.

The operation and physical configuration of a lifting columns 160 is not limited, but can involve a rotating core 162 positioned within a housing 164 that can be arranged to prevent debris and other interference from altering the translation of mechanical energy from a transmission 166 to a traveler 168 and an attached load 148 via supporting arm 170, or platform. While the traveler 168 can be the lone component that traverses the core 162 in response to core rotation, various embodiments employ one or more safety nuts 172 that are also vertically manipulated by core rotation. The inclusion of a safety nut 172 ensures that any failure in the traveler 168, such as stripped threads, cracks, or cross-threading, results in minimal vertical displacement of the attached load 148 as the arm 170 will fall only into contact with the nut 172.

It is contemplated that the nut 172 is positioned in contact with the traveler 168 so that each component concurrently moves about the core 162 as a unitary assembly. However, such unitary configuration can result in inadvertent friction, heat, and stress that jeopardizes the performance, reliability, and safety of the core 162 and lifting column 160 as a whole. For instance, the combination of traveler 168 and nut 172 can place undue forces on a single thread or portion of the core 162 when heavy loads 148 (>10 tons) are vertically manipulated. Thus, a safety nut 172 is deliberately separated from the traveler 168 in some embodiments by a nut gap 174 to provide safety from traveler 168 failure without placing excessive force on the core 168, transmission 166, or downstream motor 142.

Although the mechanical configuration of the traveler 168 and nut 172 on the core 162 can be operated at will and manually inspected at any time, it is noted that operational defects and degraded performance may occur while the core 162 is rotating and the traveler/nut are moving, which is dangerous to manually inspect. Hence, one or more sensors 176 can be positioned inside, or outside, the housing 164 to monitor one or more operational characteristics of the lifting column 160 without any danger to a user.

Various embodiments can utilize any number of sensors 176 of one or more type to detect operational conditions associated with traveler 168 and nut 172 vertical manipulation. As a non-limiting example, acoustic, optical, mechanical, and environmental sensors can be placed throughout the housing 164 to measure the operating parameters associated with lifting, and lowering, such a temperature, humidity, moisture content, rotational speed, distance from the top of the core 162, distance to the bottom of the core 162, stress, tension, cracks, plastic deformation, and dimensions of one or more threads of the core 162.

With the nearly unlimited sensor 176 configuration possibilities for a lifting column 160, operation can be closely monitored and collected data can be used to alter core 162 operation. For example, core 162 rotation speed and/or scheduled service actions that can proactively, or reactively, altered to ensure safe, reliable, and consistent future lifting column 160 operation. It is noted that the ability to accurately and reliably measure assorted dimensions and distances within the housing 164 is critical to the ability to monitor current operational conditions as well as adjust operating parameters to optimize future operation.

One measurement that would optimize the sensing of lifting column 160 dimensions and operation is the nut gap distance 178 between the nut 172 and traveler 168. However, the typically small nut gap 174 (<1 inch) is difficult to accurately sense. That is, a small nut gap 174 distance, which may be 0.25 inches or less, creates difficulties in positioning a sensor 176 within, or proximal to, the nut gap 174 to accurately provide real-time operational measurements, particularly with the heat, stress, and presence of grease in the nut gap 174 during operation.

Accordingly, various embodiments are directed to a nut gap monitoring system that utilizes one or more sensors 176 to accurately measure the nut gap 174 during operation. FIGS. 5A & 5B respectively depict portions of an example lifting column 190 configured in accordance with some embodiments to provide optimized operation over time and despite the presence of operational degradation, errors, and/or failures detected by at least one nut gap system. The side view line representation of FIG. 5A illustrates how a traveler 192 is separated from a nut 194 on a rotating core 162 by a nut gap distance 178, such as 0.1-1 inch.

The traveler 192 can be constructed with a variety of different sizes, shapes, and materials that are conducive to cyclic physical loading of heavy loads. For instance, the traveler 192 may consist of a single material, such as steel, tungsten, polymer, or titanium, or may be a lamination of multiple different materials that can provide consistent strength and deformation characteristics despite extreme physical stress, heat, and vibration. Regardless the material composition, various embodiments configure the traveler 192 with a top body 196 that has a larger relative diameter to support an arm or platform and a bottom body 198 that has a smaller relative diameter.

With the nut gap 174 being small, a nut gap sensor 200 is arranged to extend through the nut 194 with at least a pin 202 that can physically contact a bottom surface 204 of the traveler 192 to allow a monitoring unit 206 determine the nut gap distance 178 between the traveler 192 and nut 194. The pin 202 can continuously extend within a conduit 208 that allows for smooth pin 202 movement and precise accuracy for unit 206 measurements. It is noted that the use of the pin 202 brings nut gap 174 measurements through the nut 194 and away from the nut gap 174 to a space that can accommodate the size and electrical connections of the monitoring unit 206.

While pin 202 movement can provide quick, accurate mechanical readings of the nut gap distance 178, some embodiments utilize non-mechanical types of sensors 176 in association with the conduit 208 that continuously extends through the nut 194. As a non-limiting example, the conduit 208 can be utilized for wires to connect the monitoring unit 206 to an optical or acoustic detector 210 positioned in, or immediately proximal to, the nut gap 174, which may or may not physically contact the bottom surface 204 of the traveler 192. It is contemplated that a mechanical sensor 200 utilizing a pin 202 can be employed in combination with another non-mechanical sensor extending through the nut 194 that utilizes a conduit 208 for electrical wiring instead of a moving pin 202.

FIG. 5B illustrates a perspective view line representation of the traveler 192 and nut 194 without the core 162 to show how threads 212 can be provided by the nut 194 to engage matching threads of a core 162. It is to be understood that the threads 212 present in the nut 194 can also be present throughout the portions of the traveler 192 that contact the core 162. The threads 212 of the nut 194 and traveler 192 may match in some aspects, such as thread pitch and thread depth, and may also be dissimilar, such as the addition of safety thread geometry in the nut 194 that is not present in the traveler 192.

The nut 194 may be free of any direct physical contact with the traveler 192, which coincides with a wider range of operational characteristics determining the nut gap distance 178. However, the nut 194 may alternatively be directly mounted to the traveler 192 via one or more fasteners extending through nut apertures 214 and into the traveler 192. The addition of direct fasteners, in addition to the conduit 208 that extends through the nut 194, can narrow the causes of nut gap distance 178 deviation and allow nut gap sensing to be more directly tied to thread degradation in the core 162 and traveler 192, which improves the ability to discern proactive and reactive actions that can optimize current and future lifting operations.

It is contemplated, but not required, that the traveler 192 is physically attached to an arm or platform. Such direct physical attachment can be facilitated with fasteners extending through traveler apertures 216 and into an arm/platform, as shown in FIG. 4. The operation of the traveler 192 to provide vertical manipulation of a load can be aided with grease or other lubricant, which can be pumped into the traveler 192 via one or more fittings 218 that provide lubrication to the physical interface between the core 162 and the threads and inner sidewalls of the traveler 192.

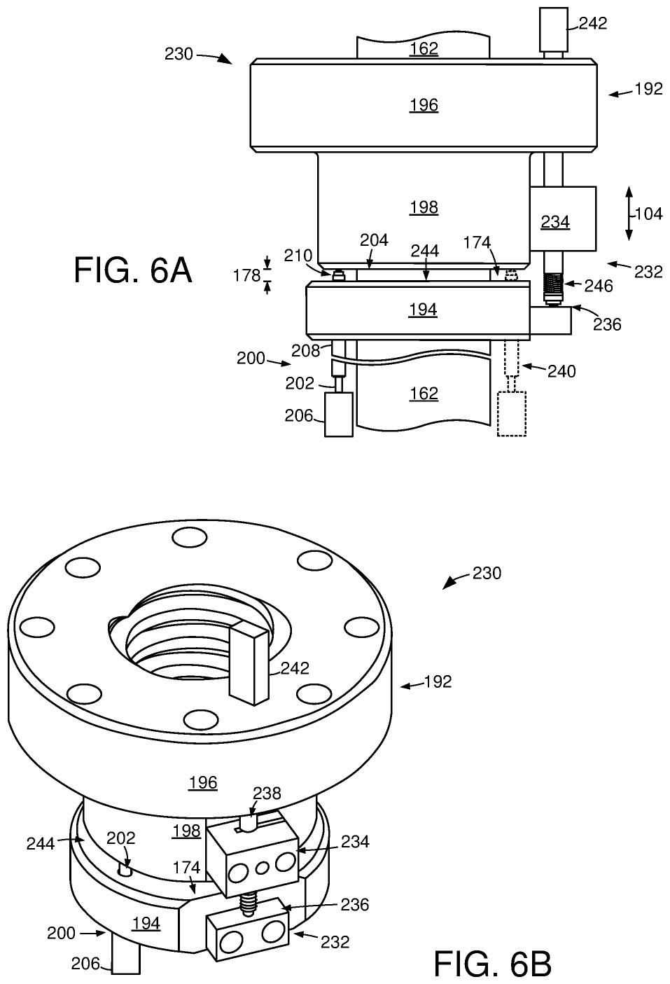

Through the accurate, real-time measurement of a nut gap 174 by one or more sensors 200, minute deviations in operation can be detected and correlated to the traveler or the core, which allows for reactive and proactive actions to be taken to modify the operational and/or structural parameters of a lifting column. While a single sensor 200 is illustrated in FIGS. 5A and 5B, assorted embodiments employ multiple sensors 200 to provide a more comprehensive measurement of the nut gap distance. FIGS. 6A & 6B respectively depict portions of an example lifting column 230 configured in accordance with various embodiments to incorporate multiple sensors around the nut gap 174 to measure the nut gap distance.

As shown in the side view line representation of FIG. 6A, a first sensor 200 and a second sensor 232 are each mechanical-type devices that respectively employ one or more pins 202 to extend through the nut gap 174 to measure the nut gap distance (D). While not required or limiting, some embodiments position the first sensor 200 within the nut 194 and areal extent of the traveler 192, as described in FIGS. 5A and 5B, while the second sensor 232 is positioned outside the areal extent of the traveler 192 and continuously extends from a mount 234 to a measuring surface 236 attached to the sidewall of the nut 194.

It is contemplated that the external second sensor 232 is arranged inverse to the first sensor 200. For instance, the pin 202 of the first sensor 200 can extend to contact the traveler 192 while a pin 238 of the second sensor 232 extends to contact the nut 194. The inverted pin configuration can provide simultaneous measurements of the nut 194 and traveler 192 while the separated position of the respective sensors 200/232 simultaneously measures different regions of the nut gap 174. The ability to select the orientation and position of the externally positioned second sensor 232 allows for intelligent and dynamic nut gap 174 monitoring. The external location of the mount 234 and measuring surface 236 allows for multiple different locations and orientations as well as the ability to add additional sensors, as shown by segmented sensor 240, and/or alter an existing sensor 232.

The perspective view line representation of FIG. 6B conveys how the second sensor 232 is arranged to continuously extend from a connection module 242 through the traveler 192 and subsequently through the mount 234 and nut gap 174 to the measuring surface 236 that is located below a top surface 244 of the nut 194. The position of the measuring surface 236 can be adjusted to allow greater pin 238 movement and higher nut gap 174 measuring resolution than the first sensor pin 202 that contacts the bottom surface 204 of the traveler. That is, the combination of sensors 200/232 with different resolutions due to different measuring locations relative to the same nut gap 174 provides robust measurement signals and a more accurate and comprehensive detection of the nut gap size, shape, and health than if sensors with a common resolution were used. In other words, the larger distance for the pin 238 to move provides a greater range for signals to indicate nut gap size, which can be particularly helpful with distances of less than an inch.

Some embodiments configure the mechanical sensors 200/232 with different types of contacting pins 202/238. For instance, the entire pin 202 can move relative to a stationary unit 206 or less than all of a pin 238 can move under tension, or expansion, force applied by one or more articulating features 246. The ability to select different pin configurations and movements allow the sensing system to be arranged to mitigate the harsh conditions contributing to normal lifting column operation, such as heat, stress, debris, and the presence of contaminants. It is noted that positioning the measuring surface 236 below the top surface 244 of the nut 194 mitigates the presence of contaminants, such as grease and oil, and allows a more sensitive pin 238 to be utilized compared to the pin 202 positioned within the areal extent of the traveler bottom body 198 and nut 194.

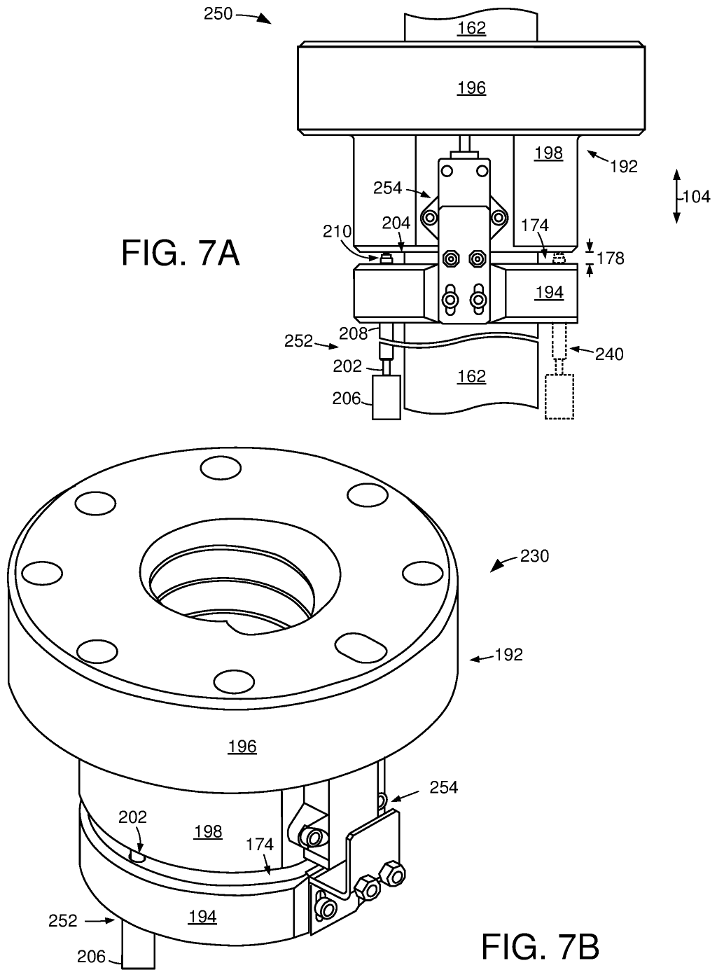

FIGS. 7A & 7B respectively depict portions of an example lifting column 250 that can be utilized in a drop table in various embodiments. FIG. 7A conveys how the lifting column 250 employs a combination of contacting sensor 252 and a non-contacting sensor 254 to accurately and efficiently map the size and shape of the nut gap 174 between the traveler 192 and nut 194. The contacting sensor 252 may be any device that utilizes physical contact for displacement or potentiometric detection of distance, acceleration, or presence, such as a spring, coil, tape, or pin. A non-contacting sensor 254 can be any device that detects distance, acceleration, or presence without physically engaging the object being measured, such as with acoustic, optical, or capacitive features that detect proximity of a surface.

The combination of different types of sensors 252/254 can provide a variety of different tunable sensing and operating characteristics. For instance, different sensor types can be configured to operate with different latencies, tolerances, ranges, and resolutions, which allows a lifting column operator to configure a nut gap sensing system with capabilities that provide accurate measurements in diverse operating conditions as well as the opportunity to selectively activate one sensor or the other. The ability to receive nut gap measurements with different characteristics allows a lifting column controller to intelligently measure a nut gap in real-time based on current conditions and adapt sensing operation to adapt to future operating conditions. For instance, a lifting column controller may operate one sensor 252/254 alone until a predetermined amount of heat occurs, debris is detected in the nut gap, or a nut gap reading has a greater than 10% change over a selected amount of time.

Some embodiments utilize different types of sensors 252/254, as shown in FIG. 7B, concurrently to gather different nut gap measurements that can be compiled by a lifting column controller to provide a more robust and complete understanding of the nut gap size, shape, and distance between a nut and traveler than if a single sensor 252/254 was employed. The utilization of sensors 252/254 positioned at different locations relative to a nut gap 174 mitigates the impact of debris and contaminates from degrading nut gap distance measurements. It is noted that a combination of sensors 252/254 positioned within the nut 194 and external to the nut 194 provides different measurement characteristics that can be complementary to recognize reading errors, quickly identify minute deviations in nut gap distance, and reduce the risk of catastrophic failures.

The availability of multiple sensors 252/254 allows for the deactivation of one or more sensors 252/254 for maintenance, replacement, or movement. As a non-limiting example, a sensor 252/254 can be deactivated while the other sensor 252/254 continues to measure the nut gap distance in real-time so that the deactivated sensor 252/254 is moved to a different location relative to the nut gap 174, replaced with a new sensor of the same type, replaced with a new sensor of a different type, or serviced by a technician.

The use of multiple different types of sensors 252/254 may, in some embodiments, allow different field of views, different resolutions, and/or different signal-to-noise ratios to be individually, and collectively, employed to provide a robust real-time reading of the nut gap distance. For instance, a lifting column controller can selectively activate and deactivate different sensors 252/254 to manipulate the measuring characteristics of the nut gap 174 and provide a real-time measurement of the distance between the nut and traveler. That is, the lifting column controller can determine what measuring characteristics provide the most accurate readings based on the operation of the lifting column, environmental conditions, sensor capabilities, and logged sensor behavior and selectively activate/deactivate sensors 252/254 to receive a particular characteristic, such as signal-to-noise ratio, latency, field of view, resolution, error rate, and range.

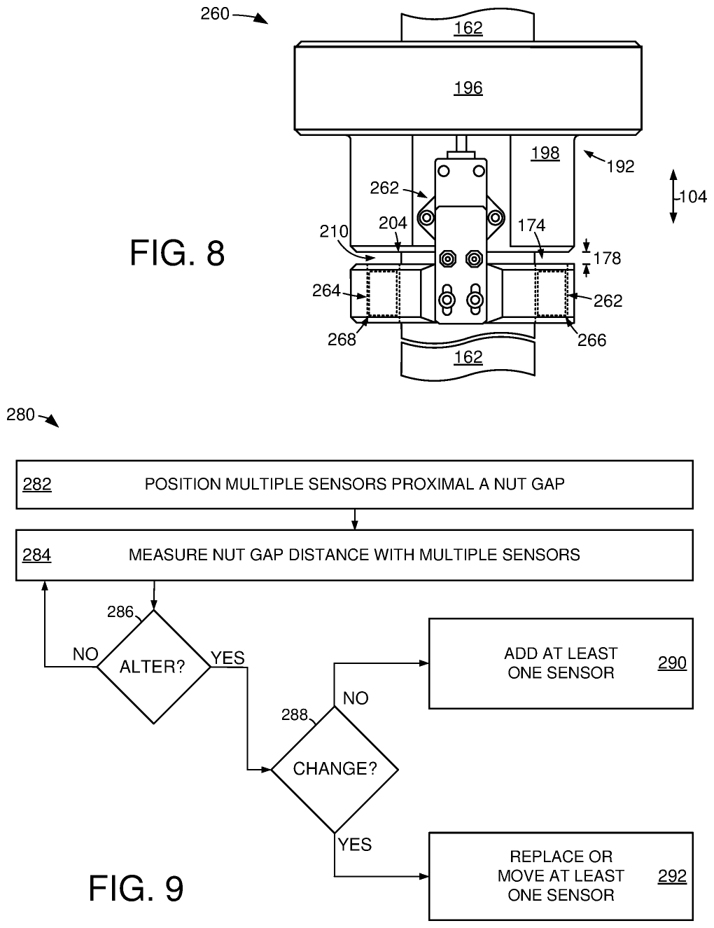

FIG. 8 depicts another non-limiting lifting column 260 that employs multiple sensors 262/264 in accordance with various embodiments. In contrast to the use of sensors that utilize mechanical features to contact and measure the nut gap, the example lifting column 260 has a sensing configuration with multiple non-contacting sensors 262/264. It is noted that while the same type of non-contacting sensor 262/264 can be employed, the respective sensors 262/264 can have different measuring characteristics, such as field of view, signal-to-noise ratio, tolerance, range, and resolution.

Although not required or limiting, some embodiments position multiple separate sensors 262/264 within respective notches 266/268 in the nut 194 to concurrently, or sequentially, measure different locations of the nut gap 174. It is contemplated that the respective notches 266/268 continuously extend through the nut 194 into the nut gap 174, which allows the non-contacting type sensor 262 to be replaced with a contacting type sensor that extends a mechanical feature, such as a pin, into the nut gap, as shown in FIG. 5A.

The combination of non-contacting type sensors 262/264 internally and externally positioned relative to the nut 194 can mitigate the impact of heat and/or nut gap contamination on sensor operation. As such, it is contemplated that an internally positioned sensor 262 is active until a threshold amount of heat and/or gap contamination is detected and the externally positioned sensor 264 is active thereafter to provide redundant, or exclusive, nut gap distance measurements. The structure of the nut 194 and traveler 192, in some embodiments have predetermined mounting locations for different sensors positioned to allow efficient sensor interchangeability as well as diverse operating capabilities to measure a nut gap 174. For example, the lifting column 260 can have one or more unoccupied sensor mounting locations contained wholly within the nut 194 and/or external to the nut 194 to allow additional, contacting and/or non-contacting, sensors to be utilized along with the ability to relocate an existing sensor 262/264 to measure the nut gap 174 differently.

FIG. 9 depicts an example sensor routine 280 that may be executed as part of a lifting column in some embodiments. The routine 280 begins with a lifting column arranged with a nut gap between a nut and traveler that are each positioned on a rotating core. A plurality of sensors are positioned proximal the nut gap in step 282 to provide redundant, or dissimilar, sensing characteristics for different aspects of the lifting column. It is noted that step 282 is not limiting and any number and type of sensors can be employed to concurrently or sequentially detect a nut gap distance between the nut and traveler in step 284. For instance, a first sensor can continuously extend through the nut into the nut gap to contact the traveler while a second sensor can extend from the traveler to a measurement surface extending from the nut. Another non-limiting example of step 284 utilizes a mechanical sensor in conjunction with an acoustic, optical, magnetic, or inductive sensor.

While step 284 can be executed continuously, cyclically, or sporadically over time, some embodiments evaluate in decision 286 if an alteration to the nut gap sensing configuration can optimize the accuracy and/or reliability of the lifting column. If no sensing alteration is deemed necessary in decision 286, the routine 280 returns to step 284 where nut gap detection continues or restarts. In the event decision 286 determines that altering the current sensing configuration can improve accuracy, efficiency, and/or reliability, decision 288 proceeds to evaluate if changing a sensor can optimize sensing and/or operating parameters. That is, decision 288 can determine if changing the type, size, and/or position of a current sensor can provide enhanced operation and/or increased nut gap distance measurement accuracy.

Step 290 adds at least one sensor if decision 288 determines a no existing sensor change can increase lifting column operation or nut gap measurement accuracy. The number, type, size, and position of an added sensor in step 290 is not limited, but some embodiments add a redundant sensor outside the areal extent of the nut/traveler while other embodiments add a different sensor within the areal extent of the nut/traveler. A determination in decision 288 that an existing sensor change can benefit the lifting column advances to step 292 where at least one sensor is replaced or otherwise changed to a new position relative to the nut gap. It is noted that operation of the lifting column may, or may not, be halted during the sensor change of step 292, which can involve measuring the nut gap with a secondary sensor while a primary sensor is changed, for example.

The ability to change an existing sensor is similar to the ability to retroactively fit a sensor to a lifting column that previously did not employ a sensor or a sensor of a particular type. As a non-limiting example, a lifting column can have one or more attachment features installed, such as threaded holes, keyed protrusions, or adhesive, that positions portions of a contact or non-contact type sensor where a sensor was not previously installed. Another example retro-fit application involves changing to a different type of sensor within the nut or external to the nut by attaching one or more installation features, such as a mount, measuring surface, or retaining clip.

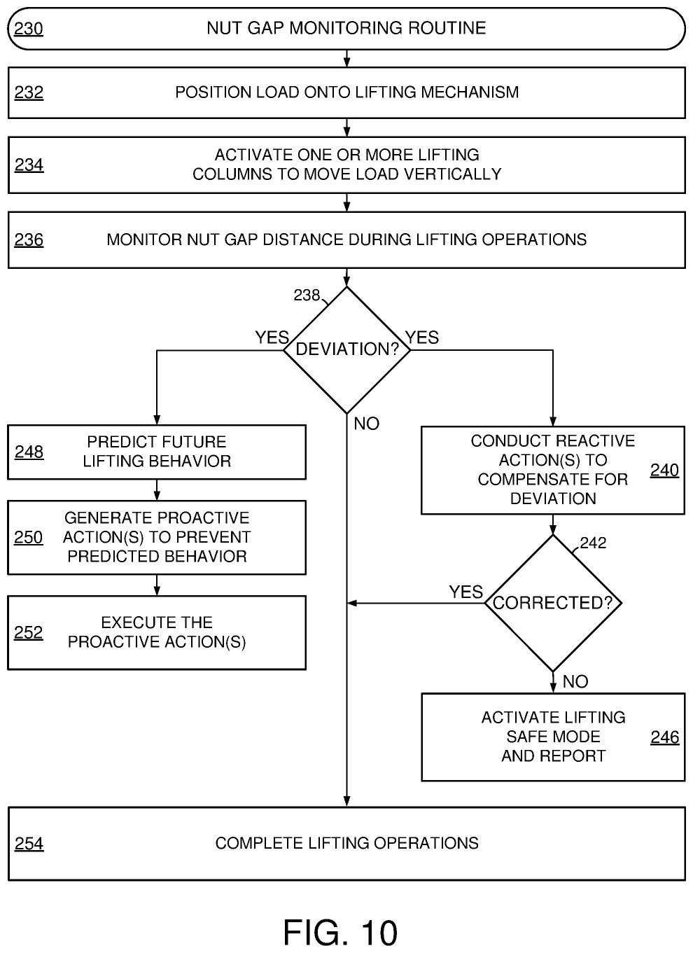

FIG. 10 is a flowchart of an example nut gap sensing routine 300 that can be carried out with the assorted embodiments of FIGS. 1-9 to provide optimal vertical manipulation of loads over time. The routine 300 can begin with one or more lifting columns being implemented in a machinery maintenance system that can at least vertically move a heavy load, such as 50 tons, with a lifting mechanism.

Step 302 positions a load onto arms, or a platform, supported by various lifting columns of a lifting mechanism. Some embodiments of step 2302 provide a drop table where four lifting columns are physically connected via a base and a moving platform. Physical attachment of the load to the respective lifting columns allows step 304 to activate one or more motors/engines that power operation of the lifting columns as a collective unit. Step 304, in some embodiments, involves activating dual motors that each power two lifting columns in unison to lower, or raise, the attached load a selected distance.

During the lifting operations started in step 304, step 306 monitors the nut gap distance of at least one lifting column with at least one sensor that extends through a safety nut. Such sensor may consist of a pin, electrical wires, or optical cable extending from a monitoring unit to the nut gap where measurements are accurately taken and reported to a host in real-time. A host may be a user or programmable controller configured to log and react to nut gap distance measurements. The nut gap distance measuring in step 306 may be continuous, sporadic, or in scheduled intervals to convey if a deviation in nut gap distance is experienced.

Decision 308 can operate concurrently, or sequentially, with step 306 to determine if a nut gap deviation has occurred. If so, a host can conduct one or more reactive actions to compensate for the detected deviation in step 310. A reactive action may be to slow down lifting operations, speed up lifting operations, pump more grease into a traveler, reduce grease pressure into a traveler, or stopping lifting operations altogether.

Decision 312 then evaluates the effectiveness of the reactive action(s) by monitoring nut gap distance, perhaps with greater time resolution than in step 306. If the lifting operations have improved and no further nut gap deviation is experienced, the load is moved into a final position in step 314. However, if nut gap deviations remain or have newly occurred, step 316 proceeds to activate motor safe mode and report the maintenance system for service. Such safe mode may involve a deactivated motor, increased safety locks, or activation of a supplemental lifting mechanism to assist in moving the load to a desired height.

While lifting operations can reactively be optimized through the accurate measuring of a nut gap distance and generation of intelligent actions to correct, or mitigate, such deviations, the ability to proactively prevent deviations in nut gap distance provides a lifting column with long-term reliability and safety. The detection of actual nut gap deviations in decision 308 may also trigger a host to predict future lifting behavior in step 316 based on the detected nut gap deviations. For example, a temporary nut gap distance deviation at a particular location on a rotating core can be used to predict future greater deviations as degradation in core threads persist. As another non-limiting example, a continuous nut gap deviation can be used to predict traveler damage that will increase at a known rate, such as linear or exponential.

The prediction of one or more future lifting behaviors in step 316 enables step 318 to generate one or more proactive actions that can be conducted in the future to prevent at least one predicted behavior. For instance, grease can be scheduled to be removed from a lifting column core, a traveler can be physically reinforced, or certain portions of a core can be treated with greater, or lesser, core rotation and lifting operation speed. At a convenient time after step 318 generates the proactive action(s), such as when a load is not being supported, step 320 then executes one or more proactive actions generated from step 318.

Through the use of a nut gap monitoring sensor that can accurately detect nut gap distance in real-time, the operation of a lifting column can be understood and improved over time. The ability to identify reactive and proactive actions from nut gap measurements that can correct, or at least mitigate, current deviations in lifting column operations while preventing other lifting deviations ensures inevitable operational deviations do not jeopardize short-term or long-term safety, reliability, or efficiency.

It is to be understood that even though numerous characteristics of various embodiments of the present disclosure have been set forth in the foregoing description, together with details of the structure and function of various embodiments, this detailed description is illustrative only, and changes may be made in detail, especially in matters of structure and arrangements of parts within the principles of the present technology to the full extent indicated by the broad general meaning of the terms in which the appended claims are expressed. For example, the particular elements may vary depending on the particular application without departing from the spirit and scope of the present disclosure.

What is claimed is:

1. A method comprising:
positioning a nut and traveler on a rotating core, the nut separated from the traveler by a nut gap;
measuring the nut gap with a first sensor positioned within the nut, the first sensor detecting a nut gap distance with a first sensing feature; and
changing the first sensor to a second sensor, the second sensor detecting the nut gap distance with a second sensing feature, the first sensing feature being different than the second sensing feature.

2. The method of claim 1, wherein the first sensing feature is a pin continuously extending from within the nut, through the nut gap, to contact the traveler.

3. The method of claim 1, wherein the second sensing feature is a proximity detector.

4. The method of claim 1, wherein the second sensing feature is a pin continuously extending through the traveler, through the nut gap, to contact a measuring surface extending from the nut.

5. The method of claim 2, wherein the second sensing feature is a pin continuously extending from within the nut, through the nut gap, to contact the traveler.

6. The method of claim 1, wherein the second sensor has a different resolution than the first sensor.

7. The method of claim 1, wherein the second sensor is installed in response to a detected change in the nut gap.

8. A method comprising:
positioning a nut and traveler on a rotating core, the nut separated from the traveler by a nut gap;
lifting a load by activating the rotating core;
adding at least one attachment feature to the nut; and
installing a sensor to measure the nut gap while contacting the at least one attachment feature.

11. The method of claim 8, wherein the first sensor is a different type than the second sensor.

12. The method of claim 8, wherein the first sensor and second sensor are the same type of sensor.

13. The method of claim 8, wherein the first sensor is an acoustic sensor.

14. The method of claim 8, wherein the first sensor is a mechanical sensor.

15. The method of claim 8, wherein the first sensor is an optical sensor.

16. A method comprising:
positioning a nut and traveler on a rotating core, the nut separated from the traveler by a nut gap;
measuring a first portion of the nut gap with a first sensor positioned within the nut, the first sensor detecting a nut gap distance with a first sensing feature; and
measuring a second portion of the nut gap with a second sensor, the second sensor detecting the nut gap distance with a second sensing feature, the first sensing feature being different than the second sensing feature.

17. The method of claim 16, wherein the first sensor and second sensor concurrently measure the nut gap.

18. The method of claim 16, wherein the first portion is within an areal extent of the nut and the second portion is external to the areal extent of the nut.

19. The method of claim 16, wherein the first portion is within an areal extent of the nut and the second portion is within the areal extent of the nut.

20. The method of claim 16, wherein the second sensor continuously extends through the traveler to a measuring surface, the measuring surface separated from a surface of the nut facing the nut gap.
